(19) United States
(12) Patent Application Publication
(10) Pub. No.: US 2009/0327164 A1
(43) Pub. Date: Dec. 31, 2009

(54) LOAD DISTRIBUTING METHOD, COMPUTER PRODUCT, AND LOAD DISTRIBUTING APPARATUS

(75) Inventors: Hitoshi Saito, Kawasaki (JP); Takuya Honda, Kawasaki (JP); Masahiro Sueda, Kawasaki (JP); Shinji Sugatani, Kawasaki (JP)

Correspondence Address: STAAS & HALSEY LLP, SUITE 700, 1201 NEW YORK AVENUE, N.W., WASHINGTON, DC, 20005, US

(73) Assignee: MICROELECTRONICS LIMITED, Tokyo (JP)

(21) Appl. No.: 12/553,201

(22) Filed: Sep. 3, 2009

Related U.S. Application Data
(63) Continuation of application No. PCT/JP2007/055394, filed on Mar. 16, 2007.

(51) Int. Cl. G06Q 20/00; G06F 9/50; G06F 15/16

(52) U.S. Cl. 705/400; 709/201; 709/226

(57) ABSTRACT

A load distributing method includes receiving information concerning resources of a terminal device from the terminal device in a grid on a network of a grid computing system; extracting, from a computation data group related to grid computing and based on the received information concerning resources, computation data corresponding to the resources; and distributing to the terminal device, the extracted computation data together with content reproducible during processing of the computation data.

### FIELD

The embodiment discussed herein is related to load distribution and grid computing.

### BACKGROUND

In the fields of biotechnology, physics, design, finance, meteorology, etc., enormous and complicated calculation processes are performed for data analysis. An enterprise or a public institution that executes such calculation processes has to purchase a high-performance supercomputer or multiple computers in place of a supercomputer, or to contract out (outsource) calculation processes to a contractor having such computer facilities.

In recent years, grid computing has been gaining popularity as a technique by which a complicated calculation or program may be executed in a short period without an expensive supercomputer. FIG. 12 is a schematic of grid computing.

As depicted in FIG. 12, a grid computing (GC) provider providing grid computing services receives, from a grid user requesting the GC provider to perform GC-based processing, an enormous data group and a grid fee for processing the data group. The grid user may be an enterprise or a public institution requiring execution of enormous and complicated calculation processes in the fields of biotechnology, physics, design, finance, meteorology, etc., or may be an enterprise that receives a contract for such calculation processes.

The GC provider is an enterprise that carries out grid computing, and is, for example, an Internet provider. The GC provider distributes computation data (data subject to computation), as for example a batch job, to a user who has entered a provider contract with the GC provider, and receives the computation result for the computation data (batch job) from the user and sends the computation result to the grid user. While software development and applications utilizing this grid computing technique have been advancing, such software development and applications are hardly promoted as business activities.

An example of a conventional distributed data processing system involves a data processing system in which a central server divides received computing processes into smaller process units to enable distributed processing, while a user terminal requests the central server to send a process unit to the user terminal to execute a computing process (see, e.g., Japanese Laid-Open Patent Publication No. 2001-344199). Today, household terminals and office terminals are connected to networks via the Internet, etc. and on-line transactions are conducted using electronic money.

Employing a supercomputer to carrying out enormous and complicated calculation processes, however, poses a problem of extremely high introduction and maintenance costs of the supercomputer. Even if multiple inexpensive terminals are purchased as a substitute for the supercomputer to perform the calculation processes, the same problem arises.

As the Internet becomes widespread with better organized peripheral facilities, household terminals and office terminals are constantly connected around the clock to the network under a fixed monthly charge subscription, allowing easy data communication anytime via the network.

The processing capability of terminals as processors is improved greatly while the capacity of memories is increased. Terminals for general users are also improved in the same manner. In the present situation, however, a terminal is not always operated to use its maximal processing capability in a regular manner and application programs are not always in constant use.

### SUMMARY

According to an aspect of an embodiment, a load distributing method includes receiving information concerning resources of a terminal device from the terminal device in a grid on a network of a grid computing system; extracting, from a computation data group related to grid computing and based on the received information concerning resources, computation data corresponding to the resources; and distributing to the terminal device, the extracted computation data together with content reproducible during processing of the computation data.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a schematic diagram of a network business utilizing grid computing according to an embodiment of the present invention;

FIG. 2 is a configuration of a grid computing system according to the embodiment;

FIG. 3 is a block diagram of a computer apparatus depicted in FIG. 2;

FIG. 4 is an explanatory diagram of the content of a user DB;

FIG. 5 is an explanatory diagram of an Internet access fee information/score table;

FIG. 6 is an explanatory diagram of a computation data volume/score table;

FIG. 7 is an explanatory diagram of a content viewing/listening fee information/score table;

FIG. 8 is an explanatory diagram of a supply time period/score table;

FIG. 9 is an explanatory diagram of the contents of a reserve fund DB;

FIG. 10 is a block diagram of a functional configuration of a load distributing apparatus (GC server) according to the embodiment;

FIG. 11 is a flowchart of a load distributing procedure by the GC server; and

FIG. 12 is a schematic of grid computing.

### DESCRIPTION OF EMBODIMENTS

Preferred embodiments of the present invention will be explained with reference to the accompanying drawings.

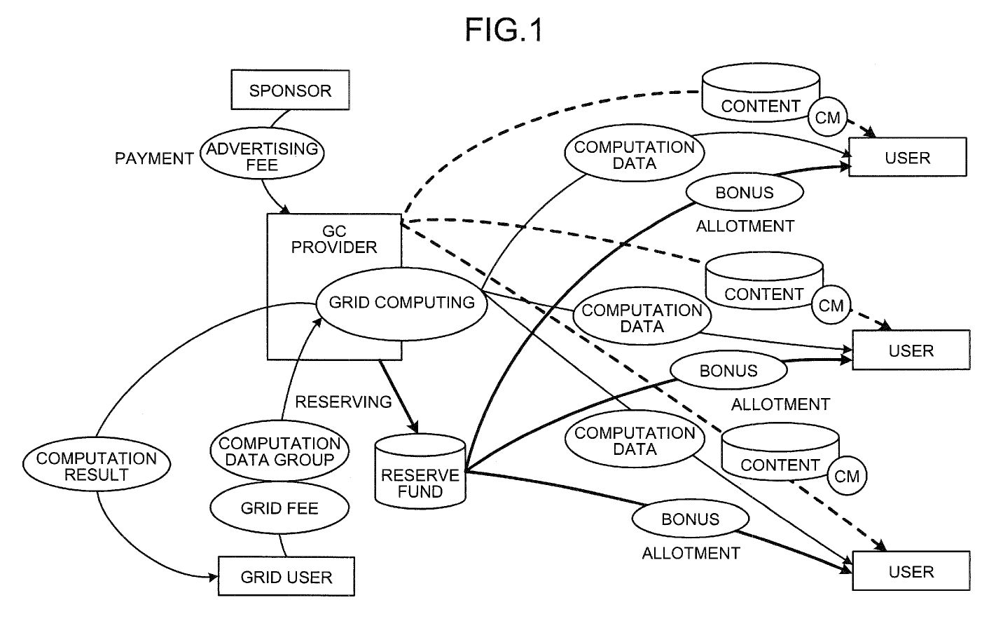

FIG. 1 is a schematic diagram of a network business utilizing grid computing according to an embodiment of the present invention.

As depicted in FIG. 1, a GC provider carrying out grid computing receives, from a grid user requesting the GC provider to carry out GC-based processing, an enormous data group and a grid fee for processing the data group. The grid user may be an enterprise or a public institution requiring execution of enormous and complicated calculation processes in the fields of biotechnology, physics, designing, finance, meteorology, etc., or is an enterprise that receives a contract for such calculation processes.

The GC provider is an enterprise that carries out grid computing, and is, for example, an Internet provider. The GC provider distributes computation data (data subject to computation), as for example a batch job, to a user who is under contract with the GC provider, and receives a computation result from the user and sends the computation result to the grid user.

The GC provider distributes on-demand content (hereinafter, simply “content”) in the form of, for example, data streams when distributing computation data. The content may be selected by the GC provider or by the user.

A sponsor, i.e., advertiser pays the GC provider an advertising fee, which allows the sponsor to insert an advertisement in the content. The user makes a provider contract with the GC provider, which allows the user to access the Internet. The user pays the GC provider an Internet access fee. The user provides resources to the GC provider and receives computation data corresponding to the resources, processes the computation data, and returns the computation result to the GC provider.

The GC provider reserves part of grid fees, advertising fees, and Internet access fees to pool a reserve fund. The GC provider allots a bonus from the reserve fund to a user who has supplied resources. The bonus is allotted in various forms, such as prize money, a discounted or zero Internet access fee, a discounted or zero content viewing/listening fee, and bonus points awarded in commercial transactions concerning sponsor goods or services. In these forms, part of the reserve fund is returned to the user.

An advertisement inserted into content is run, for example, at the beginning or in the middle of the content during the reproduction of the content. When the advertisement is run in the middle of the content, a video of the advertisement is displayed on the entire screen or the advertisement is displayed on the edge of the screen as a caption, image, video, etc.

Various genres of sponsor advertisements may be prepared for each sponsor or multiple genres of sponsors may be prepared. In this manner, preparing multiple genres of advertisements enables presentation of advertisements that meet various interests of the users. When multiple advertisements are prepared or there are multiple sponsors, income from advertising fees increase as the number of advertisements or sponsors increase, which enables a reduction in the price of content.

The user performs a user registration process at the personal computer of the user and sends user registration information to the GC provider. In the user registration process, user interests information concerning hobbies, favorite foods, etc., of the user is entered so that an advertisement meeting the interests of the user is selected from among the genres of advertisements. The CG enterprise then distributes the content including the selected advertisement to the user.

In this manner, the GC provider and the grid user are able to reduce the cost of introduction and maintenance of a supercomputer by utilizing the grid computing technique. Because the GC provider is supplied with resources from the user in exchange for the bonus, resource supplying users increase. As a result, securing resources becomes easier, which enables a reduction in a GC-utilized execution period.

While the user performs a computing process corresponding to resources of the user's personal computer, the user is allowed to view/listen to content during the computing process and thus, is able to effectively use the computer even during the computing process. In addition, because of an advantage of being able to get the bonus for a computing process on computation data, resource supplying users increase.

Hence, a favorable cycle is created where resource supplying users increase→a CG-utilized execution period is reduced→grid users assemble→incomes (grid fees) from grid users increase→the bonus increases→resource supplying users increase→ . . . .

An increase in resource supplying users leads to an improvement in the effectiveness of the advertising for the sponsor, so that the number of sponsors desiring to participate in the CG-utilized network business increases. As a result, sponsor income (advertising fees) increase, which increases the amount of the reserve fund and thus, consequently increases the bonus.

Hence, a favorable cycle is created where resource supplying users increase→content/advertisement viewing/listening users increase→sponsors assemble→sponsor incomes increase→the bonus increases→resource supplying users increase→ . . . .

As a result, facility costs to the GC provider are reduced, resource supply is facilitated, the operation environment of a personal computer of a resource supplying user is maintained, and the effect of advertising is improved. As a result, the network business becomes more active.

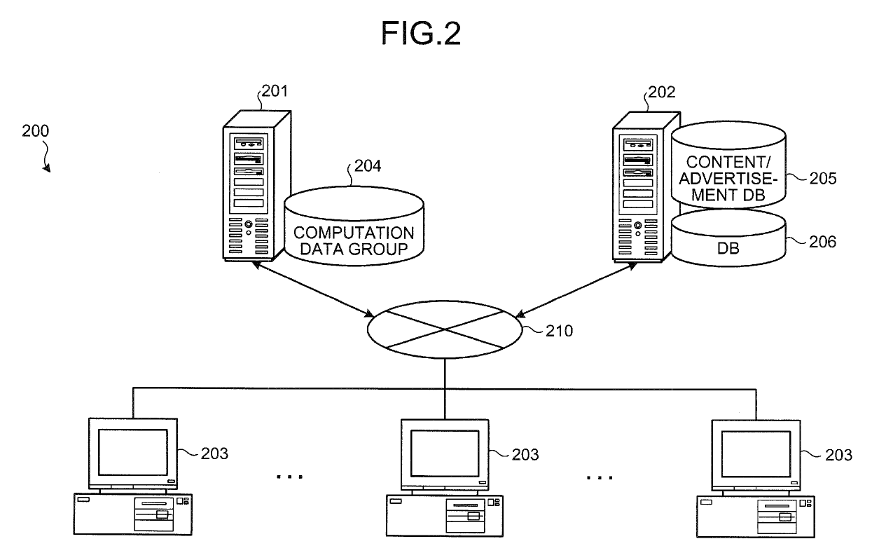

FIG. 2 is a configuration of a grid computing system according to the embodiment. As depicted in FIG. 2, a grid computing system 200 includes a grid user server 201, a GC provider server (hereinafter, “GC server”) 202, and a user terminal device (personal computer) 203 that are interconnected communicatively via a network 201, such as the Internet, etc.

The grid user server 201 is a computer that stores a computation data group 204 related to enormous and complicated computing processes in the fields of biotechnology, physics, designing, finance, meteorology, etc. The grid user server 201 transmits the computation data group 204 to the GC server 202 and receives a computation result from the GC server 202.

The GC server 202 is a computer (load distributing apparatus) that executes grid computing. The GC server 202 receives resource information from the user terminal device 203, divides the computation data group 204 received from the grid user server 201, and transmits, to the terminal device 203, computation data of a volume corresponding to the resources supplied by the terminal device 203. The GC server 202 then receives a computation result from the terminal device 203 and forwards the computation result to the grid user server 201.

The GC server 202 has a content/advertisement DB 205 and a DB 206 storing various types of information. The content/advertisement DB 205 stores therein content related to dramas, sports, movies, animation, etc. and advertisements that are inserted into the content, and distributes content and advertisements together with computation data. The DB 206 stores therein a user DB, a reserve fund DB, and various tables.

The terminal device 203 is a computer used by a user. The terminal device 203 may be a personal computer used at the home of the user or a computer used at work. The terminal device 203 is able to access the Internet when the user makes a provider contract with the GC provider and pays an Internet access fee based on the contract.

The terminal device 203 transmits resource information of the terminal device 203 and a content distribution request to the GC server 202 and receives computation data and content. The terminal device 203 then reproduces the content and executes a computing process with respect to the computation data. The result of the computation is uploaded to the GC server 202.

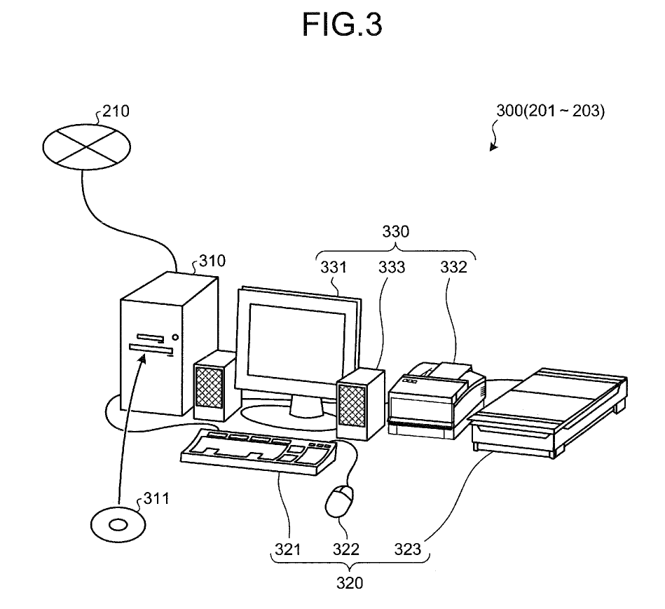

FIG. 3 is a block diagram of a computer apparatus depicted in FIG. 2. As depicted in FIG. 3, a computer apparatus 300 includes a computer 310, an input device 320, and an output device 330, and may be connected with a network 210, e.g., a local area network (LAN), a wide area network (WAN), or the Internet through a non-depicted router or a modem.

The computer 310 has a central processing unit (CPU), a memory, and an interface. The CPU governs overall control of the computer apparatus 300. The memory is formed of, for example, read-only memory (ROM), a random access memory (RAM), a hard disk (HD), an optical disk 311, or a flash memory. The memory is used as a work area of the CPU.

Various programs are stored in the memory and loaded in response to a command from the CPU. The reading and the writing of data with respect to the HD and the optical disk 311 are controlled by a disk drive. The optical disk 311 and the flash memory are removable. The interface controls input from the input device 320, output to the output device 330, and transmission/reception with respect to the network 210.

As the input device 320, a keyboard 321, a mouse 322, and a scanner 323 are adopted. The keyboard 321 includes keys to input, for example, characters, numeric figures, and various kinds of instructions, and data is input through the keyboard 321. The keyboard 321 may be a touch panel. The mouse 322 is used to move a cursor, select a range, move a window, or change window size. The scanner 323 optically reads an image as image data, which is stored in the memory of the computer 310. The scanner 323 may have an optical character recognition (OCR) function.

As the output device 330, a display 331, a printer 332, a speaker 333, etc. are adopted. The display 331 displays a cursor, an icon, or a tool box as well as data, such as text, an image, and function information. The printer 332 prints image data or text data. The speaker 332 outputs sound, e.g., a sound effect or a text-to-voice converted sound.

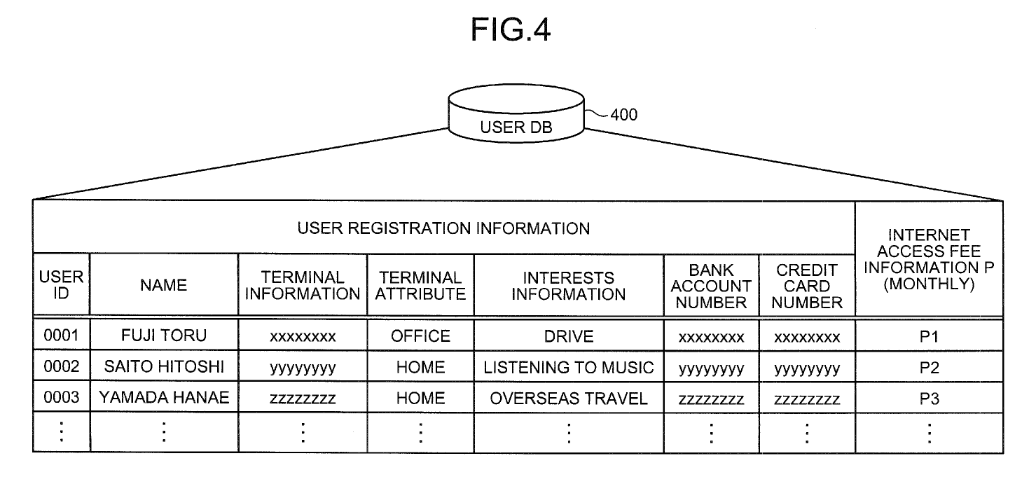

FIG. 4 is an explanatory diagram of the content of a user DB 400. As depicted in FIG. 4, user registration information and Internet access fee information (monthly) for each user is stored in the user DB 400.

User registration information includes a user ID for identifying a user, a user name, terminal information concerning the terminal device 203 used by a user (e.g., MAC address), a terminal attribute, interests information, a bank account number, and a credit card number. This user registration information is input to the terminal device 203 and is transmitted to the GC server 202, where the user registration information is stored in the user DB 400. The terminal attribute is information for identifying the terminal device 203 as a terminal device for office-use or that for home-use, and is information for identifying a time period in which the utilization rate of the terminal device 203 is low.

Internet access fee information P is information for indicating the fee that the user pays the GC provider for Internet access, and may be information of an actual amount of money or a rank corresponding to an amount of money. In the user DB 400, the Internet access fee information P is expressed as ranks P1, P2, P3, . . . . For example, the rank P1 represents a course of the highest fee, and the ranks P2 and P3 follow the rank P1.

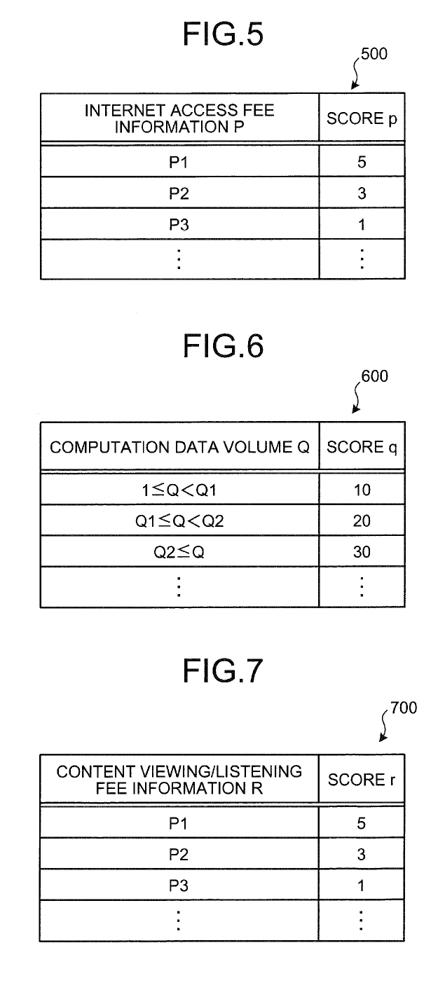

FIG. 5 is an explanatory diagram of an Internet access fee information/score table 500. As depicted in FIG. 5, the Internet access fee information/score table 500 is a table in which the Internet access fee information P is correlated with a score p for the information P. The higher the corresponding rank, the higher the score p is set.

FIG. 6 is an explanatory diagram of a computation data volume/score table. As depicted in FIG. 6, the computation data volume/score table 600 is a table in which a computation data volume Q is correlated with a score q for the data volume Q. The larger the corresponding computation data volume Q, the higher the score q is set.

FIG. 7 is an explanatory diagram of a content viewing/listening fee information/score table. As depicted in FIG. 7, the content viewing/listening fee information/score table 700 is a table in which content viewing/listening fee information R is correlated with a score r for the information R. The content viewing/listening fee information R is set in advance according to the type of content. The higher the corresponding rank, the higher the score r is set.

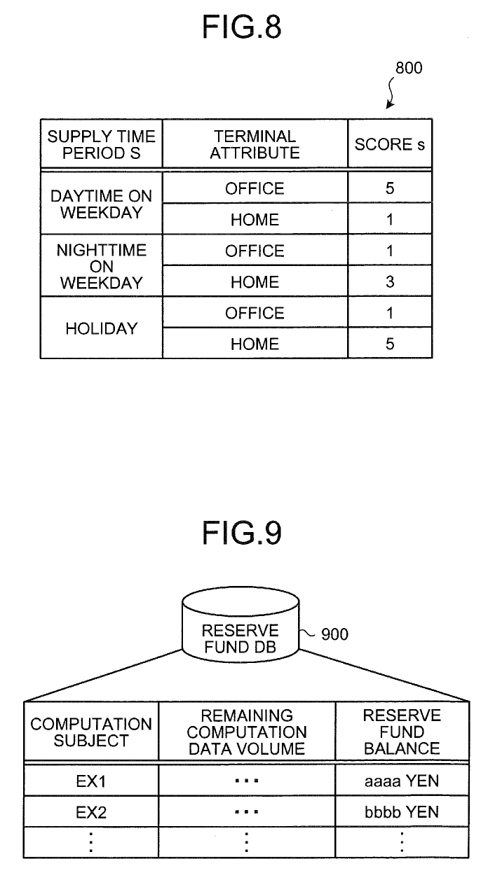

FIG. 8 is an explanatory diagram of a supply time period/score table. As depicted in FIG. 8, the supply time period/score table 800 is a table in which a resource supply time period S is correlated with a score s for the time period S. The score s is set higher as a load on the terminal device 203 increases, based on a combination of the supply time period S and a terminal attribute. Because securing the terminal device as a resource supplier is difficult during certain time periods, the score s is set higher for those time periods to facilitate securing of the terminal device as a resource supplier.

The above scores p to s affect the amount of a bonus and the probability of bonus award. Specifically, for example, the higher the scores p to s are, the higher the amount of the bonus and the probability of winning the bonus are. This encourages the user to positively and quickly supply resources.

FIG. 9 is an explanatory diagram of the contents of a reserve fund DB 900. The reserve fund DB 900 stores therein a remaining computation data volume and a reserve fund balance for each computation subject. The computation subject represents the computation data group 204 consisting of enormous and complicated data in the fields of biotechnology, physics, designing, finance, meteorology, etc., that are to be processed according to a request from the grid user. For example, a computation subject EX1 represents meteorological simulation and a computation subject EX2 represents operation simulation for circuit design.

The remaining computation data volume represents the volume of computation data that has not been delivered to the user terminal device 203. When the remaining computation data volume reduces to zero, distribution of the computation data comes to an end. The reserve fund balance represents information concerning the balance of a reserve fund that is accumulated by reserving grid fees, Internet access fees, advertising fees, etc. The reserve fund balance is updated when part of the reserve fund is given to the user as a bonus. When the balance reduces to zero, bonus allotment comes to an end.

In this manner, each time the bonus is awarded, the reserve fund is reduced by the amount equivalent to the bonus causing the user feel that the user will fail to get the bonus if the user does not supply resources ahead of others and thus, encourages the user to positively and quickly supply resources. In particular, determining the amount of the bonus to be XX % of the reserve fund making the user cognizant that the quicker resources are supplied, the higher the amount of the bonus will be. This encourages the user to positively and quickly supply resources.

Although a reserve fund balance is set for each computation subject in the example depicted in FIG. 9, the reserve fund may be set common to all computation subjects. Although the reserve fund decreases in a time-dependent manner in the example depicted in FIG. 9, the amount of the reserve fund may be fixed.

The above DBs are implemented by recording media such as ROM, RAM, and HD. The content/advertisement DB 205 and the DB 206 may be incorporated in the load distributing apparatus or in an external server with which communication can be made via the network 210.

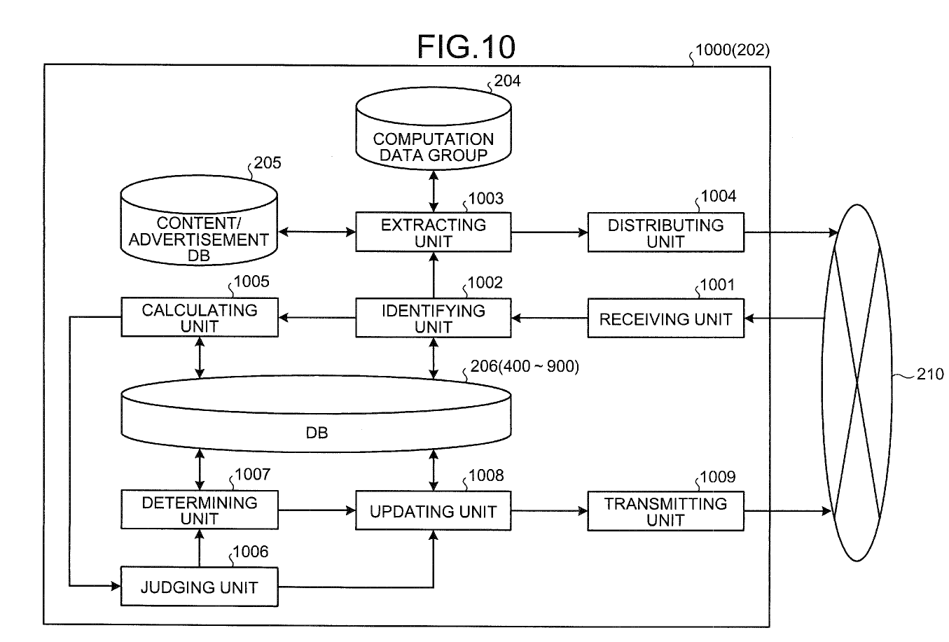

FIG. 10 is a block diagram of a functional configuration of the load distributing apparatus (GC server 202) according to the embodiment.

As depicted in FIG. 10, a load distributing apparatus 1000 includes the content/advertisement DB 205, the DB 206, a receiving unit 1001, an identifying unit 1002, an extracting unit 1003, a distributing unit 1004, a calculating unit 1005, a judging unit 1006, a determining unit 1007, an updating unit 1008, and a transmitting unit 1009.

The respective functions of the functional units 1001 to 1009 are implemented by causing a processor in the load distributing apparatus 1000 to execute programs that concern the functions and are stored in a memory in the load distributing apparatus 1000, or through an input/output I/F.

Data output from the functional units 1001 to 1009 are saved in a memory. The respective functions of connection destination units indicated by arrows in FIG. 10 are implemented by reading, from the memory, data output from the connection origin unit and causing the processor in the load distributing apparatus 1000 to execute a program concerning the respective functions.

The receiving unit 1001 has a function of receiving information. Specifically, the receiving unit 1001 receives resource information concerning the terminal device 203 from the terminal device 203. The resource information is information indicating a CPU utilization rate, available memory remaining, etc., of the terminal device 203. The resource information includes user identification information, such as a user ID and terminal information. When the user intends to select content by himself or herself, the resource information also includes a content acquiring request.

The identifying unit 1002 has a function of identifying the user of the terminal device 203 that has transmitted resource information. Specifically, for example, the identifying unit 1002 is capable of identifying the user and interests information of the user by referring to the user DB 400 using the user ID and terminal information included in the user identification information as a clue.

The extracting unit 1003 has a function of extracting computation data. Since a computation data extracting process is a basic process in the grid computing technique, detailed description of the computation data extracting process is omitted herein. Computation data corresponding in volume to the resources is extracted. This means that because the load per batch of computation data to be processed is calculated, computation data equivalent in volume to a load that can be computed using the received resources is extracted.

The extracting unit 1003 has a function of extracting content. Specifically, for example, in response to a content distribution request sent with resource information from the user terminal device 203, the extracting unit 1003 extracts the requested content from the content/advertisement DB 205. Because interests information concerning the user is identified by the identifying unit 1002, the extracting unit 1003 selects an advertisement meeting the interests of the user from the content/advertisement DB 205 and inserts the advertisement(s) into the extracted content.

When a content acquiring request is not made, content having a reproduction time longer than the time needed to perform computing process with respect to the extracted computation data may be extracted randomly or according to the interests information of the user. For example, when interests information of the user includes the name of a specific movie actor, content having a reproduction time longer than the time for performing the computing process with respect to the extracted computation data may be extracted from among movie content in which the movie actor appears.

The distributing unit 1004 has a function of distributing extracted computation data and content to the terminal device 203 serving as a resource supplier. The distributed content is reproduced by the terminal device 203 serving as the resource supplier, and the distributed computation data is processed by the terminal device 203.

In this case, the reproduction of the content may be allowed only during processing of the computation data by the resource supplier terminal device 203. At the terminal device 203, therefore, the computing process with respect to the computation data is executed while content reproduction is in progress. This allows the user to view/listen the content without being conscious of the computing process.

Usually, the screen of the terminal device 203 displays the content and other application programs are not executed during the viewing/listening of the content. Consequently, the computing process is executed without putting an excessive load on the terminal device 203.

The calculating unit 1005 has a function of calculating a bonus-award probability indicating the probability that a bonus will be awarded to a user who has supplied resources. Specifically, for example, because the user is identified by the identifying unit 1002, the Internet access fee information P can be read out from the user DB 400. The score p is then read out, referring to the Internet access fee information/score table 500 depicted in FIG. 5.

The data volume Q of the extracted computation data is identified by the extracting unit 1003. The score q is thus read out, referring to the computation data volume/score table 600 depicted in FIG. 6. When a viewing/listening fee is set for each content, the content viewing/listening fee information R is identified by extracting the content. The score r is thus read out, referring to the content viewing/listening fee information/score table 700 depicted in FIG. 7.

Because the user is identified by the identifying unit 1002, the terminal attribute can be read out from the user DB 400. The resource supply time period S is identified based on the present time. The score s is thus read out, referring to the supply time period/score table 800 depicted in FIG. 8.

A bonus-award probability is then calculated using the read out scores p to s. In a simple example, a bonus-award probability u can be calculated by the equation: u=p+q+r+s[%]. It is not necessary to use all of the tables depicted in FIGS. 5 to 8. An appropriate table may be selected as necessary. While a group of the tables 500 to 800 depicted in FIGS. 5 to 8 are referred to for bonus-award probability calculation, the bonus-award probability may be calculated using a preset calculation equation.

The judging unit 1006 has a function of judging whether the user has won the bonus based on the calculated bonus-award probability u. Specifically, for example, random numbers of 0 to 100 are generated to judge the user to be a bonus-winner, e.g., when a generated random number is equal to or less than the bonus-award probability u to the user, and to be a bonus-loser, e.g., when the generated random number is greater than the bonus-award probability u.

The determining unit 1007 has a function of determining the amount of a bonus to be awarded to the user based on a reserve fund. Specifically, for example, a fixed amount out of the reserve fund is determined to be the bonus for a user who has supplied resources. Whether the bonus is awarded as an amount of money or as bonus points may be determined by the GC server 202 or by the user.

The determining unit 1007 may determine the amount of the bonus based on the balance of the reserve fund at the time of reception of resource information. For example, when the amount of the bonus is determined to be X[%] of the reserve fund balance, the balance decreases by X[%] each time the user receives the bonus. Therefore, the slower the resources are supplied, the smaller the bonus is. In other words, quicker supply of resources leads to winning of a larger amount of the bonus. This encourages the user to positively and quickly supply resources.

The amount of the bonus may be determined by the same method of determining the bonus-award probability. For example, in the same process carried out by the calculating unit 1005, the scores p to s are read out, and the amount of the bonus is determined by the following equation using the scores p to s.

amount of bonus=(p+q+r+s)[%]×(balance of reserve fund)

The bonus points are calculated as points that correspond to the amount of the bonus calculated from this equation. It is not necessary to use all of the tables depicted in FIGS. 5 to 8, but an appropriate table may be selected according as needed. While a group of the tables 500 to 800 of FIGS. 5 to 8 is referred to for bonus amount determination, the amount of the bonus may be calculated using a preset calculation equation.

The updating unit 1008 has a function of updating the contents of the DB 206. Specifically, for example, when user registration information from the user terminal device 203 is received, the user registration information is newly registered with the user DB 400. When a bonus is calculated, the remaining computation data volume and the reserve fund balance in the reserve fund DB 900 are updated.

The transmitting unit 1009 has a function of transmitting result information, such as a bonus-winning result, the amount of the bonus, etc., to the terminal device 203 serving as a resource supplier. The transmitted information is displayed on the display of the terminal device 203.

When the bonus is won as money (amount of cash or discount), a bank account number or a credit card number is read out from the user DB 400, and the bonus money is transferred to the user through an on-line system of the financial institution or the credit card company. When bonus points are won, the bonus points are added to the user's bonus points or a request for a bonus point updating process is made through an on-line system of the sponsor.

Although calculation of a bonus-award probability, judgment on a bonus-winner, and determination of the amount of a bonus are performed in the load distributing apparatus, determination of the amount of the bonus by the determining unit 1007 may be performed without calculation of the bonus-award probability at the calculating unit 1005 and judgment at the judging unit 1006. The bonus-award probability may be given as a preset probability so that the calculation by the calculating unit 1005 is not performed.

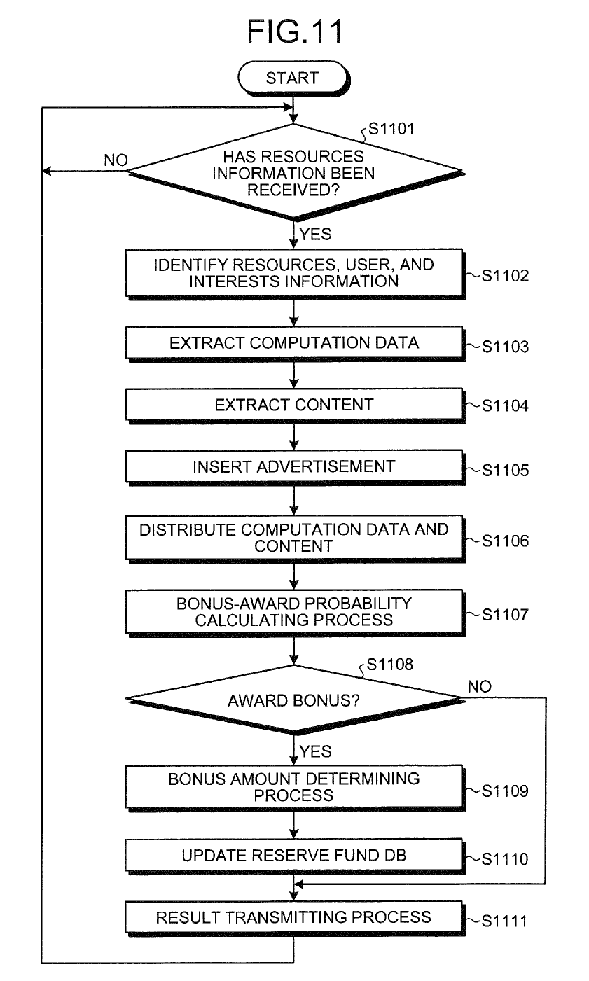

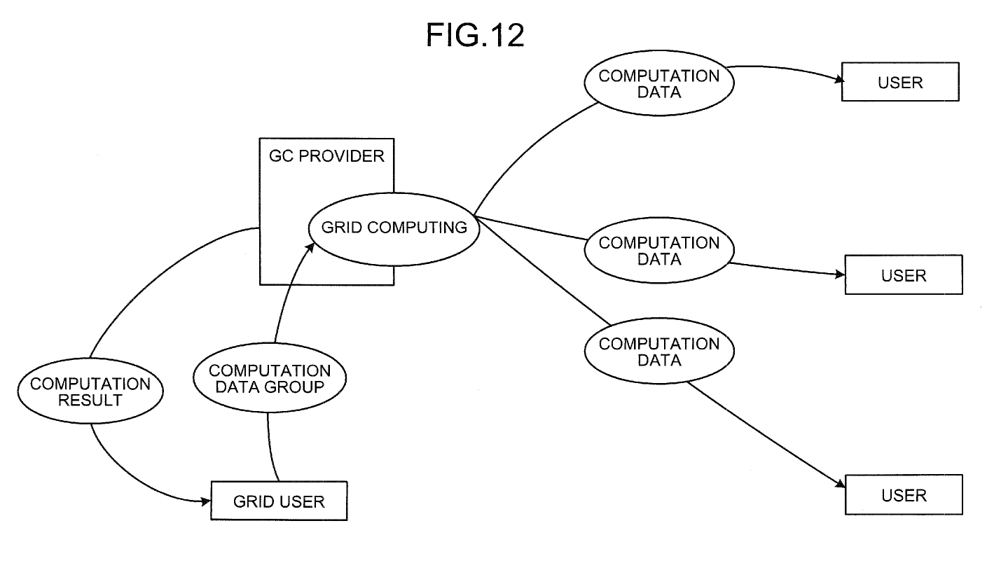

FIG. 11 is a flowchart of a load distributing procedure by the GC server 202. As depicted in FIG. 11, the receiving unit 1001 waits for resource information to be received (step S1101: NO).

When the resource information is received by the receiving unit 1001 (step S1101: YES), the identifying unit 1002 analyzes the resource information to identify resources, a user supplying the resources, and interests information concerning the user (step S1102).

The extracting unit 1003 then extracts computation data corresponding in volume to the resources (step S1103), and also extracts content having a reproduction time longer than the time needed for processing the extracted computation data, from the content/advertisement DB 205 (step S1104).

Based on the interests information concerning the user, the extracting unit 1003 extracts an advertisement meeting the interests of the user from the content/advertisement DB 205, and inserts the advertisement in the extracted content (step S1105). Subsequently, the distributing unit 1004 distributes the extracted computation data and the content (step S1106).

Following this, the calculating unit 1005 executes a bonus-award probability calculating process (step S1107). The judging unit 1006 then judges whether the user is a bonus-winner, based on a calculated bonus-award probability (step S1108). When the user is the bonus-winner (step S1108: YES), the determining unit 1007 performs a bonus amount determining process (step S1109), and the updating unit 1008 updates the remaining computation data volume and the reserve fund balance in the reserve fund DB 900 (step S1110).

When the user is not a bonus-winner (step S1108: NO), the bonus amount determining process is not performed, and the procedure proceeds to step S1111, at which a result transmitting process is executed to transmit a resulting bonus-winner, bonus amount, etc., to the user terminal device 203. Subsequently, the procedure returns to step S1101.

In this manner, according to the embodiment, the GC provider and the grid user are able to reduce the cost of introduction and maintenance of a supercomputer by utilizing the grid computing technique. Because the GC provider is supplied with resources from the user in exchange for a bonus, resource supplying users increase. As a result, securing resources becomes easier, which enables a reduction in a GC-utilized execution period.

While the user performs a computing process that corresponds to the resources of the user's personal computer, the user is allowed to view/listen to content during the computing process, thus enabling effective use of the computer even during the computing process. In addition, because of an advantage of being able to get a bonus in exchange for processing computation data, resource supplying users increase.

Hence, a favorable cycle is created where resource supplying users increase→a CG-utilized execution period is reduced→grid users assemble→incomes (grid fees) from grid users increase→the bonus increases→resource supplying users increase→ . . . .

An increase in resource supplying users leads to an improvement in the effectiveness of the advertising for the sponsor, so that the number of sponsors desiring to participate in the CG-utilized network business increases. As a result, income from sponsors (advertising fees) increases, which increases the amount of the reserve fund and consequently, the bonus increases.

Hence, a favorable cycle is created where resource supplying users increase→content/advertisement viewing/listening users increase→sponsors assemble→sponsor incomes increase→the bonus increases→resource supplying users increase→ . . . .

As described above, according to the embodiment, facility costs to the GC provider is reduced, resource supply from users is facilitated, and the operation environment of the resource supplying terminal device is maintained. As a result, the network business activity is increased.

Furthermore, the amount of a bonus may be changed depending on a level of contribution to grid computing, and a bonus-award probability can be changed depending on the level of contribution to the content distribution service.

The load distributing method explained in the present embodiment may be implemented by a computer, such as a personal computer and a workstation, executing a program that is prepared in advance. The program is recorded on a computer-readable recording medium such as a hard disk, a flexible disk, a CD-ROM, an MO, and a DVD, and is executed by being read out from the recording medium by a computer. The program may be distributed through a network such as the Internet.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment of the present invention has been described in detail, it should be understood that the various changes, substitutions, and alterations could be made hereto without departing from the spirit and scope of the invention.

What is claimed is:

1. A load distributing method comprising:
receiving information concerning resources of a terminal device from the terminal device in a grid on a network of a grid computing system;
extracting, from a computation data group related to grid computing and based on the received information concerning resources, computation data corresponding to the resources; and
distributing to the terminal device, the extracted computation data together with content reproducible during processing of the computation data.

2. The load distributing method according to claim 1, further comprising:
determining an amount of a bonus for a user of the terminal device to which the computation data and the content are distributed at the distributing, based on a reserve fund accumulated by reserving an access fee for access to the network paid by the user; and
transmitting, to the terminal device to which the content is distributed, information concerning the bonus of the amount determined at the determining.

3. The load distributing method according to claim 1, further comprising:
determining an amount of a bonus for a user of the terminal device to which the computation data and the content are distributed at the distributing, based on a reserve fund accumulated by reserving an advertisement fee paid by an advertiser to an enterprise implementing the grid computing; and
transmitting information concerning the bonus of the amount determined at the determining, to the terminal device to which the content is distributed at the distributing, wherein
the content includes an advertisement by the advertiser.

4. The load distributing method according to claim 3, wherein
the advertisement is selected from among a plurality of genres of advertisements based on interests information of the user and during reproduction of the content, is displayed on a display screen of the terminal device to which the content is distributed at the distributing.

5. The load distributing method of any one according to claims 2, wherein at the determining, the amount of the bonus is determined based on an amount of the access fee.

6. The load distributing method of any one according to claims 3, wherein at the determining, the amount of the bonus is determined based on an amount of an access fee for access to the network paid by the user.

7. The load distributing method according to claim 2, wherein at the determining, the amount of the bonus is determined based on a volume of the computation data extracted at the extracting.

8. The load distributing method according to claim 3, wherein at the determining, the amount of the bonus is determined based on a volume of the computation data extracted at the extracting.

9. The load distributing method according to claim 2, wherein at the determining, the amount of the bonus is determined based on an amount of a viewing/listening fee for the content.

10. The load distributing method according to claim 3, wherein at the determining, the amount of the bonus is determined based on an amount of a viewing/listening fee for the content.

11. The load distributing method according to claim 2, wherein at the determining, the amount of the bonus is determined based on a time period in which the computation data and the content are distributed at the distributing.

12. The load distributing method according to claim 3, wherein at the determining, the amount of the bonus is determined based on a time period in which the computation data and the content are distributed at the distributing.

13. The load distributing method according to claim 2, further comprising judging whether the user is a bonus-winner based on a bonus-award probability, wherein
at the determining, the amount of the bonus is determined when the user is judged to be the bonus-winner at the judging.

14. The load distributing method according to claim 3, further comprising judging whether the user is a bonus-winner based on a bonus-award probability, wherein
at the determining, the amount of the bonus is determined when the user is judged to be the bonus-winner at the judging.

15. The load distributing method according to claim 13, further comprising calculating the bonus-award probability based on an amount of the access fee paid by the user supplying resources, wherein
the judging includes judging whether the user is a bonus-winner based on the bonus-award probability calculated at the calculating.

16. The load distributing method according to claim 14, further comprising calculating the bonus-award probability based on an amount of an access fee for access to the network paid by the user supplying resources, wherein
the judging includes judging whether the user is a bonus-winner based on the bonus-award probability calculated at the calculating.

17. The load distributing method according to claim 13, further comprising calculating the bonus-award probability based on a volume of the computation data extracted at the extracting, wherein
the judging includes judging whether the user is a bonus-winner based on the bonus-award probability calculated at the calculating.

18. The load distributing method according to claim 14, further comprising calculating the bonus-award probability based on a volume of the computation data extracted at the extracting, wherein
the judging includes judging whether the user is a bonus-winner based on the bonus-award probability calculated at the calculating.

19. The load distributing method according to claim 13, further comprising calculating the bonus-award probability based on an amount of a viewing/listening fee for the content, wherein
the judging includes judging whether the user is a bonus-winner based on the bonus-award probability calculated at the calculating.

20. The load distributing method according to claim 14, further comprising calculating the bonus-award probability based on an amount of a viewing/listening fee for the content, wherein
the judging includes judging whether the user is a bonus-winner based on the bonus-award probability calculated at the calculating.

21. The load distributing method according to claim 13, further comprising calculating the bonus-award probability based on a time period in which the computation data and the content are distributed at the distributing, wherein
the judging includes judging whether the user is a bonus-winner based on the bonus-award probability calculated at the calculating.

22. The load distributing method according to claim 14, further comprising calculating the bonus-award probability based on a time period in which the computation data and the content are distributed at the distributing, wherein
the judging includes judging whether the user is a bonus-winner based on the bonus-award probability calculated at the calculating.

23. The load distributing method according to claim 1, further comprising extracting content from among a plurality of content, the extracted content having a reproduction time equal to or longer than a time required for processing the computation data extracted at the extracting of the computation data, wherein
the distributing includes distributing the extracted computation data together with the extracted content, to the terminal device.

24. A computer-readable recording medium storing therein a load distributing program that causes a computer to execute:
receiving information concerning resources of a terminal device from the terminal device in a grid on a network of a grid computing system;
extracting, from a computation data group related to grid computing and based on the received information concerning resources, computation data corresponding to the resources; and
distributing to the terminal device, the extracted computation data together with content reproducible during processing of the computation data.

25. A load distributing apparatus comprising:
a receiving unit that receives information concerning resources of a terminal device from the terminal device in a grid on a network of a grid computing system;
an extracting unit that, from a computation data group related to grid computing and based on the received information concerning resources, extracts computation data corresponding to the resources; and
a distributing unit that distributes to the terminal device, the extracted computation data together with content reproducible during processing of the computation data.
